(19) United States
(12) Patent Application Publication
(10) Pub. No.: US 2025/0060453 A1
(43) Pub. Date: Feb. 20, 2025

(54) RECEIVING APPARATUS AND ABNORMALITY DETECTING SYSTEM

(71) Applicant: Sumitomo Electric Industries, Ltd., Osaka-shi, Osaka (JP)

(72) Inventor: Hiroaki KAWANISHI, Osaka-shi, Osaka (JP)

(73) Assignee: Sumitomo Electric Industries, Ltd., Osaka-shi, Osaka (JP)

(21) Appl. No.: 18/721,207

(22) PCT Filed: Nov. 4, 2022
(86) PCT No.: PCT/JP2022/041212

§ 371 Date: Jun. 18, 2024

(30) Foreign Application Priority Data
Dec. 20, 2021 (JP) 2021-205791

(51) Int. Cl. G01S 7/40; G01S 13/06; G01S 13/89; G01S 13/91

(52) U.S. Cl. CPC G01S 7/4008; G01S 13/06; G01S 13/89; G01S 13/91

(57) ABSTRACT

A receiving apparatus mounted on a moving body includes: a receiving circuit that receives radio waves transmitted from a radio wave sensor attached to a structure installed on a road, and generates feature information including at least one of reception level, S/N ratio, and frequency of the received radio waves; a location detecting unit that detects a location of the moving body; and a recording unit that records the location of the moving body detected by the location detecting unit in association with the feature information generated by the receiving circuit on the basis of the radio waves received at the location of the moving body.

### TECHNICAL FIELD

The present disclosure relates to a receiving apparatus and an abnormality detecting system.

The present application claims priority based on Japanese Patent Application No. 2021-205791 filed on Dec. 20, 2021, the entire contents of which are incorporated herein by reference.

### BACKGROUND ART

Patent Literature 1 discloses a radio wave sensor for traffic monitoring.

### CITATION LIST

### Patent Literature

PTL 1: Japanese Unexamined Patent Application Publication No. 2000-48296

### SUMMARY OF INVENTION

A receiving apparatus according to an aspect of the present disclosure is a receiving apparatus mounted on a moving body. The receiving apparatus includes a receiving circuit configured to receive radio waves transmitted from a radio wave sensor attached to a structure installed on a road, and generate feature information including at least one of a reception level, an S/N ratio, and a frequency of the radio waves received; a location detecting unit configured to detect a location of the moving body; and a recording unit configured to record the location of the moving body detected by the location detecting unit in association with the feature information generated by the receiving circuit on the basis of the radio waves received at the location of the moving body.

An abnormality detecting system according to an aspect of the present disclosure is an abnormality detecting system configured to detect an abnormality in a radio wave sensor attached to a structure installed on a road. The abnormality detecting system includes a receiving apparatus mounted on a moving body, and a managing apparatus. The receiving apparatus includes a receiving circuit configured to receive radio waves transmitted from the radio wave sensor and generate feature information including at least one of a reception level, an S/N ratio, and a frequency of the radio waves received; a location detecting unit configured to detect a location of the moving body; and a recording unit configured to record the location of the moving body detected by the location detecting unit in association with the feature information generated by the receiving circuit on the basis of the radio waves received at the location of the moving body. The managing apparatus detects an abnormality in the radio wave sensor on the basis of the location and the feature information recorded by the recording unit.

The present disclosure can not only be implemented as a receiving apparatus that has the characteristic configuration described above or an abnormality detecting system including the receiving apparatus, but can also be implemented as a signal processing method including characteristic processing of the receiving apparatus as a step, as a computer program causing a computer to perform the method described above, or as a semiconductor integrated circuit constituting part of or the entire receiving apparatus.

### BRIEF DESCRIPTION OF DRAWINGS

FIG. 1 is a diagram illustrating an exemplary application of a radio wave sensor according to a first embodiment.

FIG. 2 is a perspective view illustrating an exemplary external configuration of the radio wave sensor according to the first embodiment.

FIG. 3 is a plan view illustrating an exemplary arrangement of radio wave sensors.

FIG. 4 is a diagram illustrating an exemplary configuration of an abnormality detecting system according to the first embodiment.

FIG. 5 is a block diagram illustrating an exemplary hardware configuration of the receiving apparatus according to the first embodiment.

FIG. 6 is a functional block diagram illustrating exemplary functions of the receiving apparatus according to the first embodiment.

FIG. 7A is a diagram illustrating how the reception level of radio waves is distributed in a detection area of the radio wave sensor.

FIG. 7B is a diagram illustrating an example of how the reception level of radio waves is distributed when the detection area of the radio wave sensor deviated from a specific area.

FIG. 7C is a diagram illustrating an example of how the reception level of radio waves is distributed when the intensity of radio waves transmitted from the radio wave sensor decreased.

FIG. 8 is a block diagram illustrating an exemplary hardware configuration of a managing apparatus according to the first embodiment.

FIG. 9 is a diagram illustrating an exemplary map generated by the managing apparatus according to the first embodiment.

FIG. 10 is a flowchart illustrating an exemplary process performed by the receiving apparatus according to the first embodiment.

FIG. 11 is a flowchart illustrating an exemplary process performed by the managing apparatus according to the first embodiment.

FIG. 12 is a diagram illustrating an exemplary radio wave irradiation range of the radio wave sensor in a vertical plane.

### DETAILED DESCRIPTION

Patent Literature 1 discloses a radio wave sensor for traffic monitoring. The radio wave sensor for traffic monitoring (hereinafter also referred to as “infrastructural radio wave sensor”) irradiates a road with radio waves and receives waves reflected from an object on the road, such as a vehicle or a pedestrian, to detect the object. The infrastructural radio wave sensor is secured to a structure installed on the road, and has a fixed point on the road as a detection area. If the angle of the infrastructural radio wave sensor is shifted, for example, by strong wind or vibration, the infrastructural radio wave sensor can no longer detect objects properly. The radio wave sensor disclosed in Patent Literature 1 measures a measurement direction, which is the direction from the radio wave sensor to a reference object, on the basis of reflected waves received, and calculates a shift of the measurement direction from the radio wave sensor to the reference object with respect to a reference direction.

### Problems to be Solved by Present Disclosure

An abnormality that occurs in the radio wave sensor is not limited to those that can be detected by the radio wave sensor, such as a shift in the angle of the radio wave sensor described above. For example, a decrease in the transmission level of radio waves decreases accuracy in detecting an object. It is difficult for the radio wave sensor to detect such a decrease in the transmission level of radio waves.

### Advantageous Effects of Present Disclosure

The present disclosure makes it possible to acquire information for determining whether a radio wave sensor has an abnormality that cannot be detected by the radio wave sensor.

### Description of Embodiments of Present Disclosure

Embodiments of the present disclosure are listed below.
(1) A receiving apparatus according to the present embodiment is a receiving apparatus mounted on a moving body. The receiving apparatus includes a receiving circuit configured to receive radio waves transmitted from a radio wave sensor attached to a structure installed on a road, and generate feature information including at least one of a reception level, an S/N ratio, and a frequency of the radio waves received; a location detecting unit configured to detect a location of the moving body; and a recording unit configured to record the location of the moving body detected by the location detecting unit in association with the feature information generated by the receiving circuit on the basis of the radio waves received at the location of the moving body. This allows the use of the feature information of radio waves received outside the radio wave sensor and the location where the radio waves have been received to determine whether the radio wave sensor has an abnormality.
(2) The receiving apparatus may further include a storage unit configured to store a specific area related to detection of an object performed by the radio wave sensor. The recording unit may record the location of the moving body in association with the feature information when the location of the moving body detected by the location detecting unit is within the specific area stored in the storage unit. This allows the use of the feature information in the specific area to determine whether normal radio waves are transmitted in the specific area.
(3) The storage unit may store the specific area that is a detection area where the radio wave sensor can detect an object in a state where the radio wave sensor has no abnormality related to transmission of the radio waves. The feature information can thus be used to determine whether the detection area is properly set.
(4) The recording unit may record the location of the moving body and the feature information in association with each other at each of multiple locations within the specific area. This allows the use of the feature information of radio waves received at each of multiple locations in the specific area to accurately determine whether normal radio waves are transmitted in the specific area.
(5) The receiving apparatus may further include an abnormality detecting unit configured to detect an abnormality in the radio wave sensor on the basis of the location and the feature information recorded by the recording unit. The receiving apparatus can thus detect an abnormality in the radio wave sensor.
(6) The abnormality detecting unit may detect the abnormality by comparing the feature information recorded by the recording unit with reference information including at least one of a proper range of reception levels, a proper range of S/N ratios, and a proper range of frequencies of the radio waves at the location of the moving body associated with the feature information. This allows the receiving apparatus to detect an abnormality in the radio wave sensor by comparing the feature information with the reference information.
(7) The moving body may be a vehicle. Radio waves can thus be received by the receiving apparatus mounted on a vehicle traveling on the road. This eliminates the need to install the receiving apparatus on the road to determine whether the radio wave sensor has an abnormality.
(8) The moving body may be a flying object. The location detecting unit may detect a location of the flying object including a height of the flying object. The recording unit may record the location in association with the feature information generated by the receiving circuit on the basis of the radio waves received at the location. This allows the receiving apparatus mounted on the flying object to receive radio waves at various heights. The feature information obtained in a three-dimensional space can thus be used to determine whether the radio wave sensor has an abnormality.
(9) An abnormality detecting system according to the present embodiment is an abnormality detecting system configured to detect an abnormality in a radio wave sensor attached to a structure installed on a road. The abnormality detecting system includes a receiving apparatus mounted on a moving body, and a managing apparatus. The receiving apparatus includes a receiving circuit configured to receive radio waves transmitted from the radio wave sensor and generate feature information including at least one of a reception level, an S/N ratio, and a frequency of the radio waves received; a location detecting unit configured to detect a location of the moving body; and a recording unit configured to record the location of the moving body detected by the location detecting unit in association with the feature information generated by the receiving circuit on the basis of the radio waves received at the location of the moving body. The managing apparatus detects the abnormality in the radio wave sensor on the basis of the location and the feature information recorded by the recording unit. An abnormality in the radio wave sensor can thus be detected by using the feature information of radio waves received outside the radio wave sensor and the location where the radio waves have been received.
(10) The managing apparatus may generate map information in which a result of detection of the abnormality is associated with the location of the radio wave sensor where the abnormality has been detected. This allows the user to check the location of the radio wave sensor having an abnormality on the map.

### Details of Embodiments of Present Disclosure

Details of embodiments of the present invention will now be described with reference to the drawings. At least some of the embodiments described below may be combined as appropriate.

### 1. FIRST EMBODIMENT

### 1-1. Radio Wave Sensor

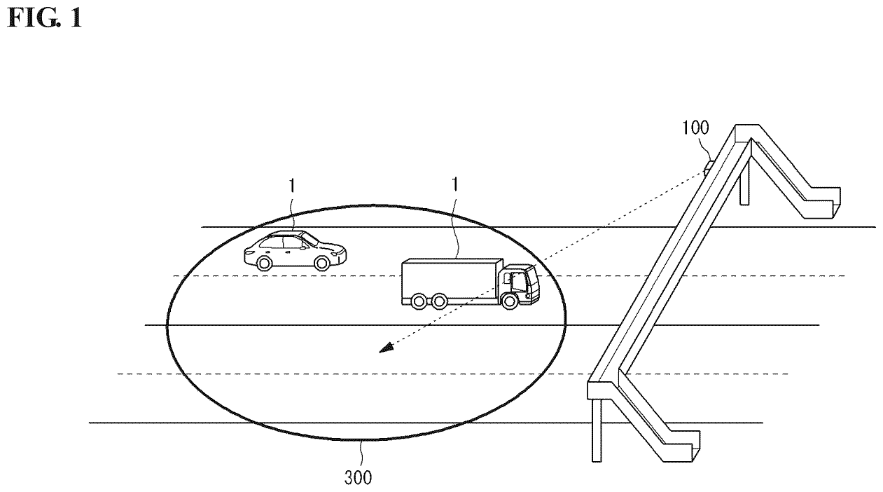

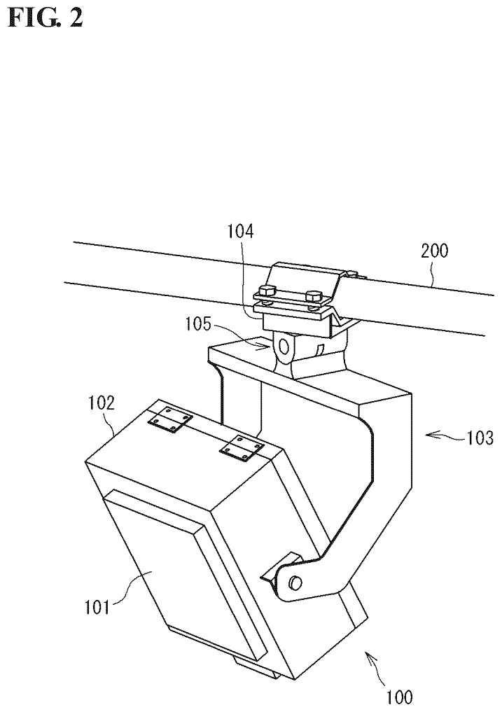

FIG. 1 is a diagram illustrating an exemplary application of a radio wave sensor according to a first embodiment. A radio wave sensor 100 according to the present embodiment is a radio wave sensor for traffic monitoring (infrastructural radio wave sensor). The radio wave sensor 100 is attached to a structure, such as an arm 200 (see FIG. 2), installed at an intersection or on a road. The radio wave sensor 100 is, for example, a millimeter wave sensor. The radio wave sensor 100 is configured to irradiate a detection area 300 on the road with radio waves (millimeter waves) and receive the reflected waves to detect an object (e.g., vehicle 1) in the detection area 300. More specifically, the radio wave sensor 100 can detect the distance to the vehicle 1 traveling on the road, the speed of the vehicle 1, and the horizontal angle (azimuth angle) of the location of the vehicle 1 with respect to the radio wave irradiation axis of the radio wave sensor 100.

The radio wave sensor 100 is installed in such a way that the direction of the radio wave irradiation axis (i.e., direction indicated by a broken line in FIG. 1; hereinafter referred to as “reference direction”) is toward the detection area 300. If the reference direction is not the correct direction, the radio wave sensor 100 cannot accurately detect an object on the road. Therefore, a maintenance worker (user) in charge of maintaining the radio wave sensor 100 adjusts the angle of the radio wave sensor 100 in such a way that the reference direction is the correct direction.

FIG. 2 is a perspective view illustrating an exemplary external configuration of the radio wave sensor 100 according to the first embodiment.

As illustrated in FIG. 2, the radio wave sensor 100 has a transmitting and receiving surface 101 configured to transmit and receive millimeter waves. The reference direction is a direction normal to the transmitting and receiving surface 101. The radio wave sensor 100 includes at least one transmitting antenna and a plurality of (e.g., two) receiving antennas. The radio wave sensor 100 transmits modulation waves, which are millimeter waves, from the transmitting antenna through the transmitting and receiving surface 101. The modulation waves hit an object and are reflected, and the reflected waves are received by the receiving antennas. In the radio wave sensor 100, a signal processing circuit (not illustrated) performs signal processing on a transmission wave signal and a reception wave signal to detect the distance to the object, the azimuth angle of the object (hereinafter also referred to as “location of the object”), and the speed of the object.

The radio wave sensor 100 is configured to be capable of adjusting the installation angle. The radio wave sensor 100 includes a sensor body 102, a depression angle adjusting unit 103, a horizontal angle adjusting unit 104, and a roll angle adjusting unit 105. The sensor body 102 has a box shape, and the depression angle adjusting unit 103 is attached to the periphery of the sensor body 102. The sensor body 102 is capable of being rotated by the depression angle adjusting unit 103 about the horizontal axis. The depression angle of the sensor body 102 is thus adjusted. The sensor body 102 connected to the roll angle adjusting unit 105, with the depression angle adjusting unit 103 therebetween, is capable of being rotated to the right and left of the transmitting and receiving surface 101 by the roll angle adjusting unit 105. The roll angle of the sensor body 102 is thus adjusted. The horizontal angle adjusting unit 104 is secured to the arm 200 to which the radio wave sensor 100 is installed. The sensor body 102 connected to the horizontal angle adjusting unit 104, with the depression angle adjusting unit 103 and the roll angle adjusting unit 105 therebetween, is capable of being rotated about the vertical axis by the horizontal angle adjusting unit 104. The horizontal angle of the sensor body 102 is thus adjusted.

The radio wave sensor 100 detects the vehicle 1 for each lane. The radio wave sensor 100 identifies the coordinates of the detected vehicle 1 in a coordinate space set in the radio wave sensor 100.

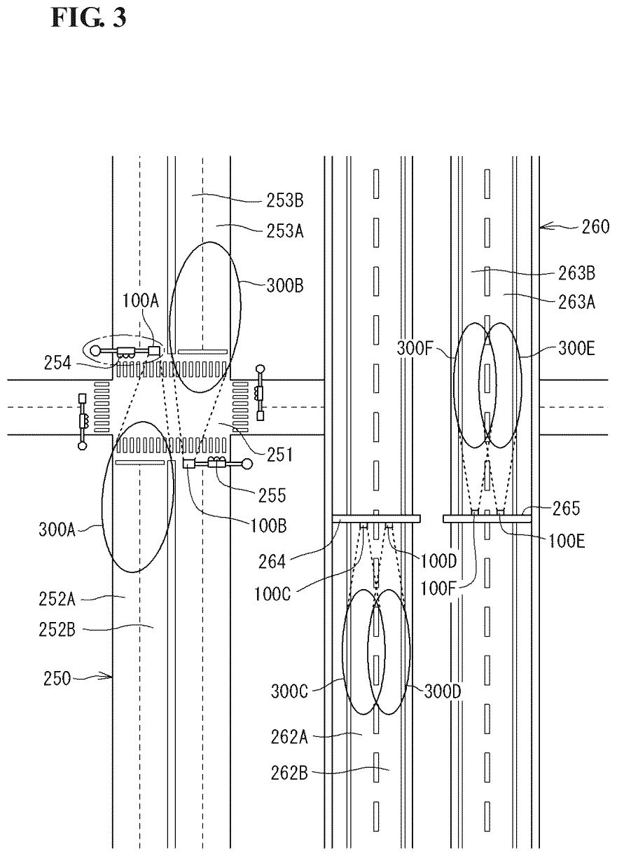

The radio wave sensor 100 described above is placed at multiple locations on the road. FIG. 3 is a plan view illustrating an exemplary arrangement of radio wave sensors. In the example illustrated in FIG. 3, radio wave sensors 100A and 100B are arranged at an intersection 251 of a road 250. The radio wave sensor 100A is attached to a traffic light 254 and forms a detection area 300A in lanes 252A and 252B. The radio wave sensor 100A is attached to a traffic light 255 and forms a detection area 300B in lanes 253A and 253B. A portal frame 264 is installed over inbound lanes 262A and 262B of an expressway 260, and a portal frame 265 is installed over outbound lanes 263A and 263B. Radio wave sensors 100C and 100D are disposed on the portal frame 264, and radio wave sensors 100E and 100F are disposed on the portal frame 265. The radio wave sensor 100C forms a detection area 300C in the lane 262A, and the radio wave sensor 100D forms a detection area 300D in the lane 262B. The radio wave sensor 100E forms a detection area 300E in the lane 263A. The radio wave sensor 100F forms a detection area 300F in the lane 263B. The traffic lights 254 and 255 and the portal frames 264 and 265 are examples of the structure.

### 1-2. Abnormality Detecting System

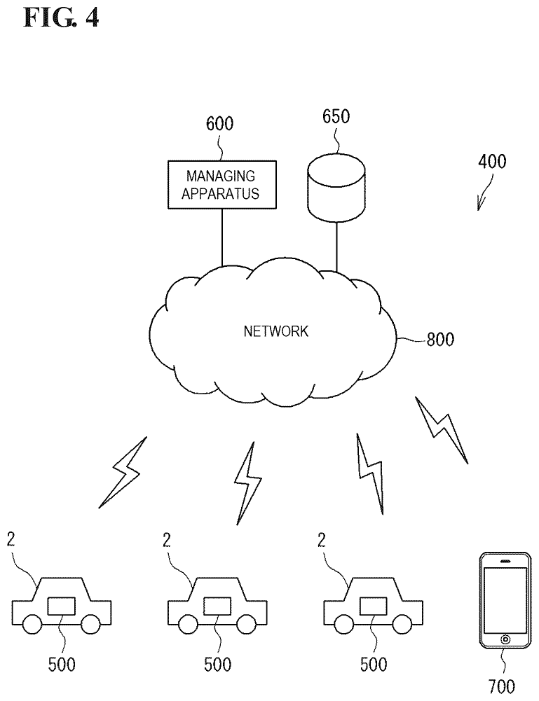

FIG. 4 is a diagram illustrating an exemplary configuration of an abnormality detecting system according to the first embodiment. An abnormality detecting system 400 includes a receiving apparatus 500, a managing apparatus 600, an inspection result database (inspection result DB) 650, and a terminal 700.

The receiving apparatus 500 is mounted on a vehicle (hereinafter referred to as “maintenance vehicle”) 2 for maintenance of road facilities. Radio waves can thus be received by the receiving apparatus 500 mounted on a vehicle traveling on the road. This eliminates the need to install the receiving apparatus 500 on the road to determine whether the radio wave sensor 100 has an abnormality. The maintenance vehicle 2 is an exemplary moving body. The receiving apparatus 500 can receive radio waves (modulation waves) emitted from the radio wave sensor 100. The receiving apparatus 500 records feature information of the radio waves received. Examples of the feature information include the reception level, S/N ratio, and frequency of the radio waves. The receiving apparatus 500 according to the present embodiment can detect an abnormality in the radio wave sensor 100 on the basis of the feature information received. The receiving apparatus 500 is capable of wireless communication. The receiving apparatus 500 can communicate with the managing apparatus 600 and the inspection result DB 650 through a network 800. The abnormality detecting system 400 includes a plurality of receiving apparatuses 500 in the example illustrated in FIG. 4, but may include only one receiving apparatus 500.

The inspection result DB 650 stores inspection result data including feature information and abnormality detection results obtained by the receiving apparatus 500. On the basis of the inspection result data stored in the inspection result DB 650, the managing apparatus 600 generates map information indicating the result of detection of abnormality in the radio wave sensor 100. The managing apparatus 600 can generate map information in which the abnormality detection result of the radio wave sensor 100 is associated with the location of the radio wave sensor 100.

The terminal 700 is constituted, for example, by an information terminal, such as a computer or a tablet. The terminal 700 is used by the maintenance worker (user) in charge of maintaining the radio wave sensor 100. The terminal 700 has a wireless communication function and can communicate with the managing apparatus 600 through the network 800. A map generated by the managing apparatus 600 is displayed on the terminal 700.

### 1-3. Receiving Apparatus

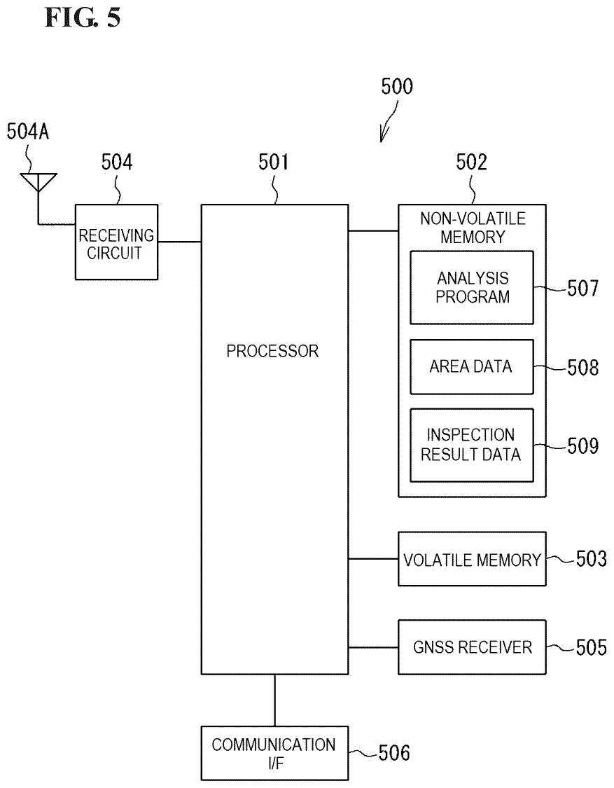

FIG. 5 is a block diagram illustrating an exemplary hardware configuration of the receiving apparatus according to the first embodiment. The receiving apparatus 500 includes a processor 501, a non-volatile memory 502, a volatile memory 503, a receiving circuit 504, a global navigation satellite system (GNSS) receiver 505, and a communication interface (communication I/F) 506.

The volatile memory 503 is, for example, a semiconductor memory, such as a static random-access memory (SRAM) or a dynamic random-access memory (DRAM). The non-volatile memory 502 is, for example, a flash memory, a hard disk, or a read-only memory (ROM). The non-volatile memory 502 stores an analysis program 507, which is a computer program, and data used to execute the analysis program 507. The non-volatile memory 502 stores area data 508. The area data 508 includes location information of a specific area that is an area to be set as a detection area of the radio wave sensor 100, and reference information for each location within the specific area. The reference information includes a proper range of reception levels of radio waves, a proper range of S/N ratios of received radio waves, and a proper range of frequencies of received radio waves. Hereinafter, a proper range of reception levels of radio waves will be referred to as a “reference range of reception levels”, a proper range of S/N ratios of received radio waves will be referred to as a “reference range of S/N ratios”, and a proper range of frequencies of received radio waves will be referred to as a “reference range of frequencies”.

The receiving apparatus 500 includes a computer, and each function of the receiving apparatus 500 is implemented when the processor 501 executes the analysis program 507, which is a computer program stored in a storage device of the computer. The analysis program 507 can be stored in a recording medium, such as a flash memory, a ROM, or a CD-ROM. The processor 501 executes the analysis program 507 and records feature information of radio waves received from the radio wave sensor 100 in the non-volatile memory 502, as described below.

Examples of the processor 501 include, but are not limited to, a central processing unit (CPU). The processor 501 may be a graphics processing unit (GPU). The processor 501 may be, for example, an application specific integrated circuit (ASIC), or may be a programmable logic device, such as a gate array or a field programmable gate array (FPGA). In this case, the ASIC or the programmable logic device is configured to be capable of performing processing similar to that of the analysis program 507.

The receiving circuit 504 includes a receiving antenna 504A. The receiving antenna 504A receives reflected waves from the vehicle 1. The receiving circuit 504 performs signal processing on the reflected waves received. Feature information generated by the signal processing is fed to the processor 501. The processor 501 records inspection result data 509, including the feature information, in the non-volatile memory 502.

The GNSS receiver 505 receives a signal from a positioning satellite and calculates the location of the receiving apparatus 500 (maintenance vehicle 2). The GNSS receiver 505 outputs location information indicating the calculated location to the processor 501.

The communication I/F 506 is a wireless communication I/F, and can wirelessly communicate with an external device. For example, the communication I/F 506 can transmit the inspection result data 509 to the inspection result DB 650.

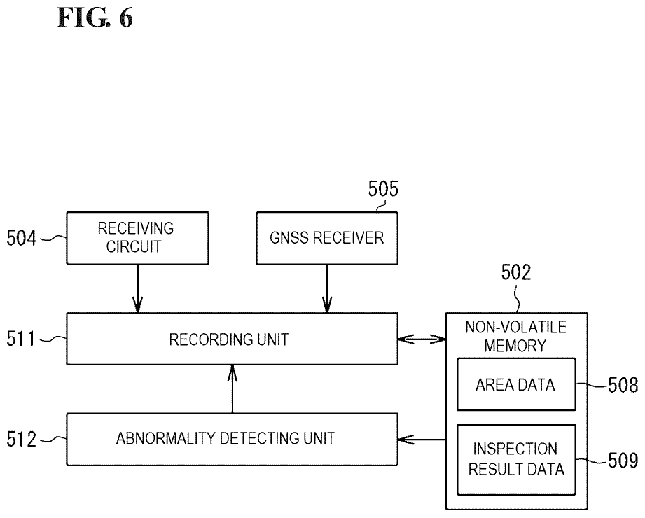

FIG. 6 is a functional block diagram illustrating exemplary functions of the receiving apparatus 500 according to the first embodiment. The receiving apparatus 500 implements the functions of the recording unit 511 and the abnormality detecting unit 512 when the processor 501 executes the analysis program 507.

The receiving circuit 504 receives radio waves transmitted from the radio wave sensor 100, and generates feature information including the reception level, S/N ratio, and frequency of the radio waves.

The GNSS receiver 505 detects the location of the maintenance vehicle 2. The GNSS receiver 505 is an exemplary location detecting unit.

The recording unit 511 associates the location of the maintenance vehicle 2 detected by the GNSS receiver 505 with the feature information generated by the receiving circuit 504 to generate the inspection result data 509, and records the generated inspection result data 509 in the non-volatile memory 502. This allows the use of the feature information of radio waves received outside the radio wave sensor 100 and the location where the radio waves have been received to determine whether the radio wave sensor 100 has an abnormality.

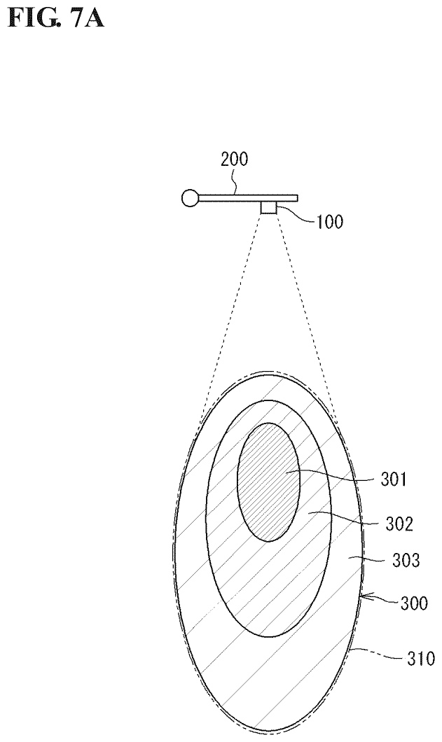

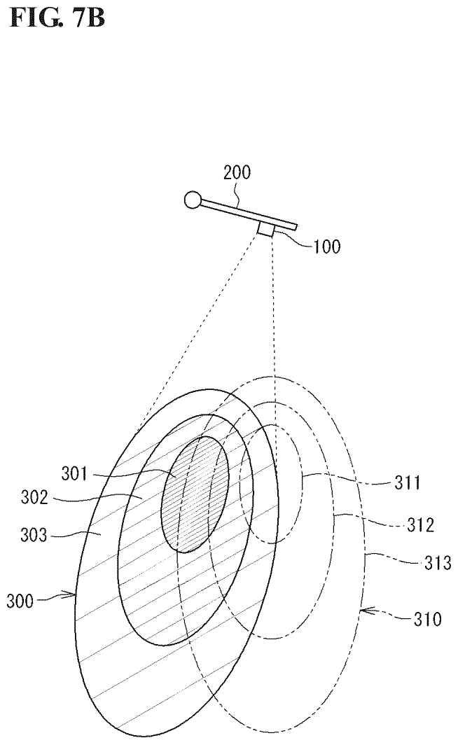

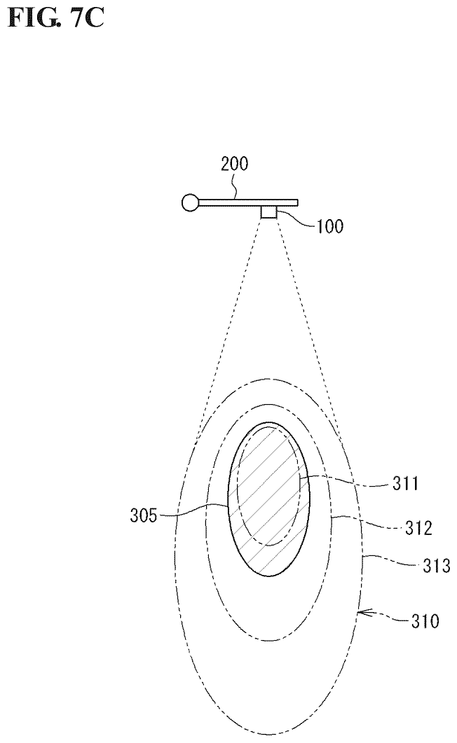

FIG. 7A is a diagram illustrating how the reception level of radio waves is distributed in a detection area of the radio wave sensor. The radio wave sensor 100 irradiates the detection area 300 with radio waves. In the detection area 300, the reception level of the radio waves varies depending on the location. That is, the detection area 300 includes a first area 301 where the reception level of the radio waves is highest, a second area 302 where the reception level of the radio waves is medium, and a third area 303 where the reception level of the radio waves is lowest.

The first area 301 where the reception level of radio waves is highest is an area where radio waves of highest intensity are received on the basis of the distance from the radio wave sensor and the antenna directivity. This area is formed at a short distance from the radio wave sensor and at an angle where the antenna gain is high. The third area 303 where the reception level of radio waves is lowest is an area where the reception level satisfies a level at which an object, such as a vehicle, can be detected but the reception level does not have a large margin. The second area 302 where the reception level of radio waves is medium is an area located between the two areas described above. A determination of one of the first area 301, the second area 302, and the third area 303 is made by comparing the reception level of radio waves with a preset threshold.

For the radio wave sensor 100 to correctly detect an object on the road, the detection area 300 needs to be set properly. In the present embodiment, a specific area 310, which is a proper area as the detection area 300, is used to properly set the detection area 300. The specific area 310 is an area to be set as a detection area of the radio wave sensor 100, and is a detection area of the radio wave sensor 100 in a state where the radio wave sensor 100 has no abnormality in transmitting radio waves. The feature information in the specific area can thus be used to determine whether the detection area 300 is properly set. The position and angle of the radio wave sensor 100 are adjusted in such a way that the detection area 300 coincides with the specific area 310. In the example illustrated in FIG. 7A, the detection area 300 coincides with the specific area 310.

For example, if the position or angle (i.e., reference direction) of the radio wave sensor 100 is changed by strong wind or vibration, the detection area 300 deviates from the specific area 310. FIG. 7B is a diagram illustrating an example of how the reception level of radio waves is distributed when the detection area 300 of the radio wave sensor deviates from the specific area 310. As illustrated in FIG. 7B, the specific area 310 in a state where the radio wave sensor 100 has no abnormality in transmitting radio waves includes a first specific area 311 corresponding to the proper first area 301, a second specific area 312 corresponding to the proper second area 302, and a third specific area 313 corresponding to the proper third area 303. The first specific area 311 is an area that coincides with the first area 301 when the detection area 300 coincides with the specific area 310. The second specific area 312 is an area that coincides with the second area 302 when the detection area 300 coincides with the specific area 310. The third specific area 313 is an area that coincides with the third area 303 when the detection area 300 coincides with the specific area 310. When the reference direction of the radio wave sensor 100 changes, as illustrated in FIG. 7B, the first area 301, the second area 302, and the third area 303 deviate from the first specific area 311, the second specific area 312, and the third specific area 313, respectively.

When a transmitting circuit in the radio wave sensor 100 has an abnormality, the output level of radio waves may decrease. FIG. 7C is a diagram illustrating an example of how the reception level of radio waves is distributed when the intensity of radio waves transmitted from the radio wave sensor decreases. When the output level of radio waves from the radio wave sensor 100 decreases, the detection area is reduced as illustrated in FIG. 7C. A reduced detection area 305 is smaller than the specific area 310. When the reception level of radio waves in the specific area 310 decreases, the reception level of radio waves does not satisfy a reception level expected in the first specific area 311 and the second specific area 312 even in an area where the detection area 305 overlaps the first specific area 311 and the second specific area 312.

Referring back to FIG. 6, the area data 508 includes location information of the specific area 310. For example, the area data 508 includes location information of the specific areas 310 of all the radio wave sensors 100 which are targets of abnormality detection by the abnormality detecting system 400. In the example illustrated in FIG. 3, the area data 508 includes location information of the specific area of each of the radio wave sensors 100A, 100B, 100C, 100C, 100E, and 100F.

Referring back to FIG. 6, the recording unit 511 compares location information output from the GNSS receiver 505 with location information of a specific area included in the area data 508, and determines whether the location of the maintenance vehicle 2 is within the specific area. If the location of the maintenance vehicle 2 is within the specific area 310, the recording unit 511 associates the location of the maintenance vehicle 2 with feature information output from the receiving circuit 504 to generate the inspection result data 509, and records the generated inspection result data 509 in the non-volatile memory 502. This allows the use of the feature information to determine whether normal radio waves are transmitted in the specific area.

The recording unit 511 may record the location of the moving body and the feature information in association each other at each of multiple locations within the specific area 310. This allows the use of the feature information of radio waves received at each of multiple locations within the specific area 310 to accurately determine whether normal radio waves are transmitted in the specific area 310.

The destination in which the inspection result data 509 is recorded is not limited to the non-volatile memory 502. The recording unit 511 also records the generated inspection result data 509 in the inspection result DB 650. That is, the recording unit 511 uploads the inspection result data 509 to the inspection result DB 650.

The abnormality detecting unit 512 detects an abnormality in the radio wave sensor 100 on the basis of the location and feature information recorded by the recording unit 511. The receiving apparatus 500 can thus detect an abnormality in the radio wave sensor 100. In an example, the abnormality detecting unit 512 compares feature information recorded by the recording unit 511 with reference information serving as reference for feature information at the location of the maintenance vehicle 2 associated with the feature information, and detects an abnormality in the radio wave sensor 100. The reference information includes at least one of a proper range of reception levels, a proper range of S/N ratios, and a proper range of frequencies of radio waves at the location of the moving body associated with the feature information. The receiving apparatus 500 thus compares the feature information with the reference information and can detect an abnormality in the radio wave sensor 100.

The abnormality detecting unit 512 compares a reception level included in feature information with the reference range of reception levels included in reference information. The reference range is a range defined by at least one of an upper limit and a lower limit. In the examples illustrated in FIG. 7A to FIG. 7C, a proper reception level differs in each of the first specific area 311, the second specific area 312, and the third specific area 313. The area data 508 includes reference information associated with location information. When the location information indicates a location within the first specific area 311, the reference information corresponding to the location information includes the reference range of reception levels in the first specific area 311. When the location information indicates a location within the second specific area 312, the reference information corresponding to the location information includes the reference range of reception levels in the second specific area 312. When the location information indicates a location within the third specific area 313, the reference information corresponding to the location information includes the reference range of reception levels in the third specific area 313. If a reception level included in the feature information is within the reference range, the abnormality detecting unit 512 determines that the reception level is normal. If the reception level included in the feature information is outside the reference range, the abnormality detecting unit 512 determines that the reception level is abnormal.

The abnormality detecting unit 512 compares an S/N ratio included in the feature information with the reference range of S/N ratios included in the reference information. In the examples illustrated in FIG. 7A to FIG. 7C, a proper S/N ratio differs in each of the first specific area 311, the second specific area 312, and the third specific area 313. When the location information in the area data 508 indicates a location within the first specific area 311, the reference information corresponding to the location information includes the reference range of S/N ratios in the first specific area 311. When the location information indicates a location within the second specific area 312, the reference information corresponding to the location information includes the reference range of S/N ratios in the second specific area 312. When the location information indicates a location within the third specific area 313, the reference information corresponding to the location information includes the reference range of S/N ratios in the third specific area 313. If an S/N ratio included in the feature information is within the reference range, the abnormality detecting unit 512 determines that the S/N ratio is normal. If the S/N ratio included in the feature information is outside the reference range, the abnormality detecting unit 512 determines that the S/N ratio is abnormal.

The abnormality detecting unit 512 compares a frequency included in the feature information with the reference range of frequencies included in the reference information. The frequency band that can be used in the radio wave sensor 100 is regulated by law. The reference range indicates a frequency band allowed to be used in the radio wave sensor 100. That is, in the examples illustrated in FIG. 7A to FIG. 7C, the reference range of frequencies is common to the first specific area 311, the second specific area 312, and the third specific area 313. If a frequency included in the feature information is within the reference range, the abnormality detecting unit 512 determines that the frequency is normal. If the frequency included in the feature information is outside the reference range, the abnormality detecting unit 512 determines that the frequency is abnormal.

The recording unit 511 includes an abnormality detection result obtained by the abnormality detecting unit 512 in the inspection result data 509 and records it in the non-volatile memory 502 and the inspection result DB 650. Specifically, if an abnormality in the radio wave sensor 100 is detected, the recording unit 511 records abnormality information indicating the detection of abnormality, in association with feature information included in the inspection result data 509 and in which abnormality has been detected. The abnormality information may include information indicating the type of abnormality. That is, if an abnormality in reception level is detected, the abnormality information includes information indicating the abnormality in reception level. If an abnormality in S/N ratio is detected, the abnormality information includes information indicating the abnormality in S/N ratio. If an abnormality in frequency is detected, the abnormality information includes information indicating the abnormality in frequency.

The inspection result data 509 may include an ID for identifying the radio wave sensor 100 where an abnormality has been detected, in association with the abnormality information. Thus, the managing apparatus 600 that has referred to the inspection result data 509 can easily identify the radio wave sensor 100 where an abnormality has been detected.

### 1-4. Managing Apparatus

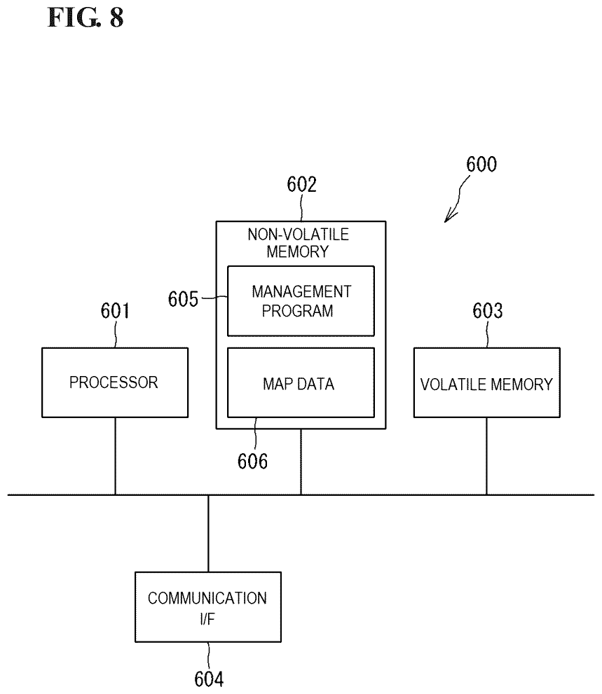

FIG. 8 is a block diagram illustrating an exemplary hardware configuration of a managing apparatus according to the first embodiment. The managing apparatus 600 includes a processor 601, a non-volatile memory 602, a volatile memory 603, and a communication I/F 604.

The volatile memory 603 is, for example, a semiconductor memory, such as an SRAM or a DRAM. The non-volatile memory 602 is, for example, a flash memory, a hard disk, or a ROM. The non-volatile memory 602 stores a management program 605, which is a computer program, and data used to execute the management program 605. Map data 606 is stored in the non-volatile memory 602. The map data includes map information of a target range of abnormality detection performed by the abnormality detecting system 400.

The managing apparatus 600 includes a computer, and each function of the managing apparatus 600 is implemented when the processor 601 executes the management program 605, which is a computer program stored in a storage device of the computer. The management program 605 can be stored in a recording medium, such as a flash memory, a ROM, or a CD-ROM. The processor 601 executes the management program 605 and maps the radio wave sensor 100 in which an abnormality has been detected, as described below.

Examples of the processor 601 include, but are not limited, a CPU. The processor 601 may be a GPU. The processor 601 may be, for example, an ASIC, or may be a programmable logic device, such as a gate array or an FPGA. In this case, the ASIC or the programmable logic device is configured to be capable of performing processing similar to that of the management program 605.

The communication I/F 506 is, for example, an Ethernet I/F (“Ethernet” is a registered trademark) and can communicate with each of the receiving apparatus 500, the inspection result DB 650, and the terminal 700 through the network 800.

The managing apparatus 600 acquires the inspection result data 509 from the inspection result DB 650 when the processor 601 of the managing apparatus 600 executes the management program 605. The managing apparatus 600 generates map information in which the result of detection of abnormality in the radio wave sensors 100 is associated with the locations of the radio wave sensors 100 where the abnormality has been detected. This allows the user to check the location of the radio wave sensor 100 having an abnormality on the map. Specifically, the managing apparatus 600 identifies, from the inspection result data 509, the radio wave sensors 100 where an abnormality has been detected. The managing apparatus 600 then maps the radio wave sensors 100 where the abnormality has been detected and the radio wave sensors 100 that are normal, separately on the map.

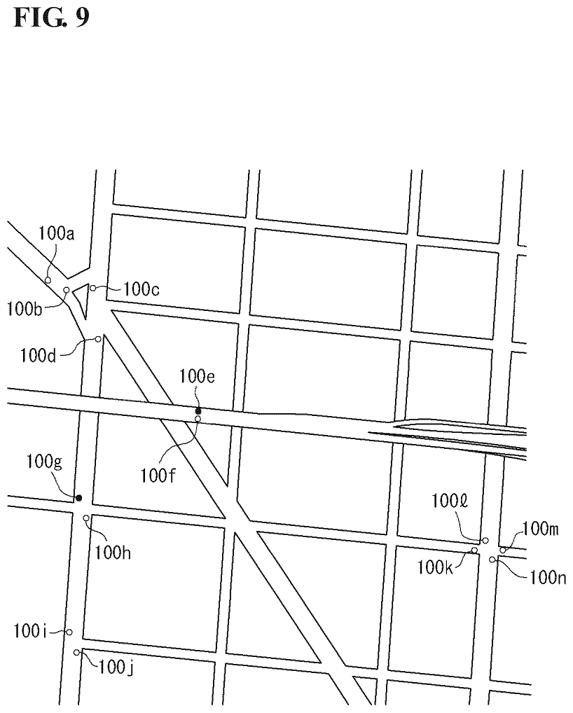

FIG. 9 is a diagram illustrating an exemplary map generated by the managing apparatus 600 according to the first embodiment. For example, the location of each of the radio wave sensors 100 is marked on the map. In the example illustrated in FIG. 9, normal radio wave sensors 100a, 100b, 100c, 100d, 100f, 100h, 100i, 100j, 100k, 100l, 100m, and 100n are marked with open circles, and radio wave sensors 100e and 100g where an abnormality has been detected are marked with filled circles.

The managing apparatus 600 can transmit a generated map to the terminal 700 in response to a request from the terminal 700. The terminal 700 can display the received map on a display. This allows the user to check the location of the radio wave sensor 100 where an abnormality has been detected on the map.

### 1-5. Operation of Abnormality Detecting System

An exemplary operation of the abnormality detecting system 400 according to the first embodiment will now be described.

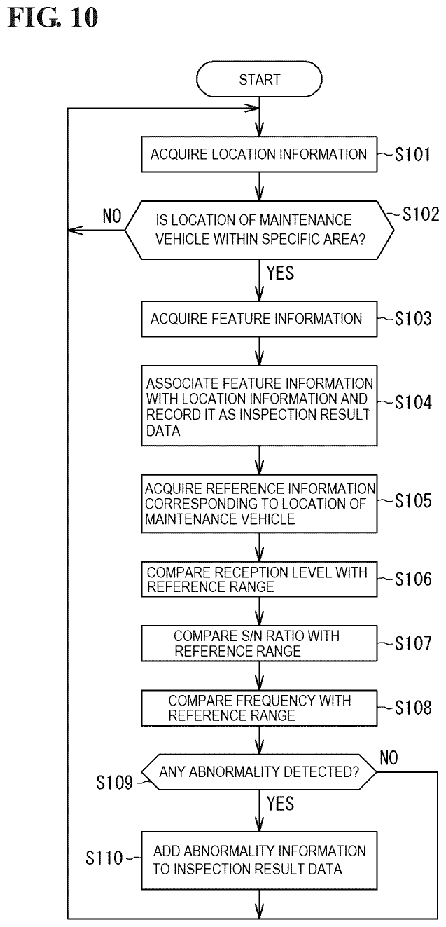

FIG. 10 is a flowchart illustrating an exemplary process performed by the receiving apparatus 500 according to the first embodiment. The receiving apparatus 500 performs the following process when the processor 501 executes the analysis program 507.

The maintenance vehicle 2 having the receiving apparatus 500 mounted thereon travels on the road in the target range of abnormality detection performed by the abnormality detecting system 400. The processor 501 of the receiving apparatus 500 acquires location information output from the GNSS receiver 505 (step S101). The location information indicates the current location of the maintenance vehicle 2.

The processor 501 compares the location information of the specific area 310 of each of the radio wave sensors 100 indicated in the area data 508, with the location information acquired from the GNSS receiver 505, and determines whether the location of the maintenance vehicle 2 is within the specific area 310 (step S102). If the location of the maintenance vehicle 2 is outside the specific area 310 (NO in step S102), the processor 501 returns to step S101.

The receiving circuit 504 outputs feature information of radio waves received. If the location of the maintenance vehicle 2 is within the specific area 310 (YES in step S102), the processor 501 acquires the feature information (step S103).

The processor 501 associates the feature information with the acquired location information and records it as the inspection result data 509 (step S104). The inspection result data 509 is recorded in the non-volatile memory 502 and the inspection result DB 650.

The processor 501 reads the area data 508 from the non-volatile memory 502, and acquires reference information corresponding to the location of the maintenance vehicle 2 indicated by the location information (step S105).

The processor 501 compares a reception level included in the recorded feature information with the reference range of reception levels included in the reference information acquired (step S106). If the reception level is within the reference range, the processor 501 determines that the reception level is normal. If the reception level is outside the reference range, the processor 501 detects an abnormality.

The processor 501 compares an S/N ratio included in the recorded feature information with the reference range of S/N ratios included in the reference information acquired (step S107). If the S/N ratio is within the reference range, the processor 501 determines that the S/N ratio is normal. If the S/N ratio is outside the reference range, the processor 501 detects an abnormality.

The processor 501 compares a frequency included in the recorded feature information with the reference range of frequencies included in the reference information acquired (step S108). If the frequency is within the reference range, the processor 501 determines that the frequency is normal. If the frequency is outside the reference range, the processor 501 detects an abnormality.

The processor 501 determines whether any abnormality has been detected in steps S106 to S108 described above (step S109). If no abnormality has been detected (NO in step S109), the processor 501 returns to step S101. If any abnormality has been detected (YES in step S109), the processor 501 adds abnormality information to the inspection result data (step S110) and returns to step S101.

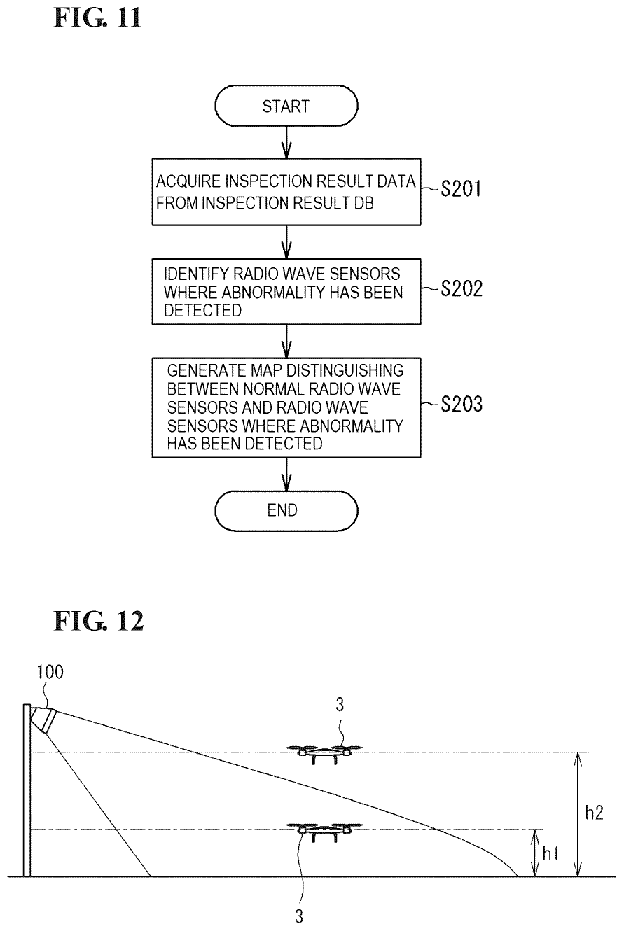

An operation of the managing apparatus 600 will now be described. FIG. 11 is a flowchart illustrating an exemplary process performed by the managing apparatus 600 according to the first embodiment. The managing apparatus 600 performs the following process when the processor 601 executes the management program 605.

The processor 601 acquires inspection result data from the inspection result DB 650 (step S201).

The processor 601 identifies, from the inspection result data acquired, the radio wave sensors 100 where an abnormality has been detected. For example, if the ID of the radio wave sensor 100 where an abnormality has been detected is included in abnormality information, the processor 601 identifies the radio wave sensor 100 with the ID. In another example, the processor 601 identifies, with location information corresponding to the abnormality information, the radio wave sensors 100 where an abnormality has been detected.

By using the map data 606, the processor 601 generates a map indicating the locations of the radio wave sensors 100 where an abnormality has been detected and the locations of the radio wave sensors 100 that are normal, separately (step S203).

The processor 601 of the managing apparatus 600 transmits the generated map to the terminal 700 in response to a request from the terminal 700. By displaying the map on the terminal 700, the user can identify the location of the radio wave sensor 100 where an abnormality has been detected.

### 2. SECOND EMBODIMENT

In the present embodiment, the receiving apparatus 500 records the inspection result data 509 that associates the feature information with the location information, and the managing apparatus 600 detects an abnormality in the radio wave sensor 100 on the basis of the inspection result data 509. That is, the managing apparatus 600 detects an abnormality in the radio wave sensor 100 on the basis of the location and feature information recorded by the recording unit 511. An abnormality in the radio wave sensor 100 can thus be detected by using the feature information of radio waves received outside the radio wave sensor 100 and the location where the radio waves have been received. Specifically, the managing apparatus 600 compares each of the reception level, S/N ratio, and frequency included in the feature information with the corresponding reference range. Then, if at least one of the reception level, S/N ratio, and frequency is outside the reference range, an abnormality in the radio wave sensor is detected.

In the present embodiment, the receiving apparatus 500 does not need to detect an abnormality in the radio wave sensor 100. If an abnormality in the radio wave sensor 100 is detected, the managing apparatus 600 adds abnormality information to the inspection result data in the inspection result DB 650.

The other configurations and operations of the abnormality detecting system according to the second embodiment will not be described, as they are the same as or similar to the configurations and operations of the abnormality detecting system 400 according to the first embodiment.

### 3. THIRD EMBODIMENT

Although the receiving apparatus 500 is mounted on the maintenance vehicle 2 in the embodiments described above, the present disclosure is not limited to this. In a third embodiment, the receiving apparatus 500 is mounted on a drone (flying object) 3 for maintenance and monitoring of road facilities.

FIG. 12 is a diagram illustrating an exemplary radio wave irradiation range of the radio wave sensor in a vertical plane. Radio waves are emitted from the radio wave sensor 100 in the reference direction (obliquely downward). The radio wave irradiation range spreads out in a conical shape from the transmitting surface. Therefore, the range in which radio waves are received changes depending on the height at which the drone 3 flies. In FIG. 12, even if the locations (latitudes and longitudes) of the drones 3 are the same in the horizontal direction, the drone 3 at height h1 is within the radio wave irradiation range, but the drone 3 at height h2 is outside the radio wave irradiation range. Accordingly, even at the same latitude and longitude, the expected reception level and S/N ratio vary depending on the height.

Referring to FIG. 6, in the present embodiment, the GNSS receiver 505 detects the location of a flying object, including the height of the flying object, and outputs location information including the location (latitude and longitude) in the horizontal direction and the altitude (elevation). The recording unit 511 records the location information including the altitude, in association with feature information generated by the receiving circuit 504 on the basis of radio waves received at the location described above. This allows the receiving apparatus 500 mounted on the flying object to receive radio waves at various heights. The feature information obtained in a three-dimensional space can thus be used to determine whether the radio wave sensor 100 has an abnormality.

The area data 508 includes reference information that varies depending on the location in the horizontal direction and the altitude. The abnormality detecting unit 512 compares each of the reception level, S/N ratio, and frequency included in the feature information with the corresponding reference range determined in accordance with the horizontal direction and the altitude, so as to detect an abnormality in the radio wave sensor 100. Note that the reference range of frequencies does not need to change in accordance with the horizontal direction and the altitude.

### 4. OTHER EMBODIMENTS

In the embodiments described above, the receiving apparatus 500 or the managing apparatus 600 compares each of the reception level, S/N ratio, and frequency with the reference range for each location to detect an abnormality in the radio wave sensor 100. The present disclosure is not limited to this. For example, the receiving apparatus 500 continuously acquires feature information (reception level, S/N ratio, and frequency) while the maintenance vehicle 2 is traveling within the specific area 310. The receiving apparatus 500 or the managing apparatus 600 determines whether, for example, a change pattern of the reception level matches a change pattern of the reception level expected on the traveling route of the maintenance vehicle 2 within the specific area 310 (hereinafter referred to as “reference pattern”). If the change pattern of the reception level matches the reference pattern, the receiving apparatus 500 or the managing apparatus 600 can determine that the radio wave sensor 100 is normal, whereas if the change pattern of the reception level does not match the reference pattern, the receiving apparatus 500 or the managing apparatus 600 can determine that the radio wave sensor 100 is abnormal.

In the embodiments described above, the receiving apparatus 500 records the location information and the feature information in association with each other when the location of the moving body (maintenance vehicle 2 or drone 3) is within the specific area (within the radio wave irradiation range). However, the present disclosure is not limited to this. For example, the receiving apparatus 500 may record the location information and the feature information in association with each other at regular intervals regardless of whether the location of the moving body is within the specific area.

### 6. ADDENDUM

The embodiments disclosed herein are illustrative in all aspects and are not restrictive. The scope of rights of the present invention is defined by the appended claims, not by the embodiments described above, and includes meanings equivalent to the claims and all changes within the scope of the claims.

### REFERENCE SIGNS LIST

1 vehicle
2 maintenance vehicle
3 drone
100, 100A, 100B, 100C, 100D, 100E, 100F, 100a, 100b, 100c, 100d, 100f, 100h, 100i, 100j, 100k, 100l, 100m, 100n radio wave sensor
101 transmitting and receiving surface
102 sensor body
103 depression angle adjusting unit
104 horizontal angle adjusting unit
105 roll angle adjusting unit
200 arm
250 road
251 intersection
252A, 252B, 253A, 253B, 262A, 262B, 263A, 263B lane
254, 255 traffic light
260 expressway
264, 265 portal frame
300, 300A, 300B, 300C, 300D, 300E, 300F, 305 detection area
301 first area
302 second area
303 third area
310 specific area
311 first specific area
312 second specific area
313 third specific area
400 abnormality detecting system
500 receiving apparatus
501, 601 processor
502, 602 non-volatile memory
503, 603 volatile memory
504 receiving circuit
504A receiving antenna
505 GNSS receiver
506, 604 communication interface (communication I/F)
507 analysis program
508 area data
509 inspection result data
511 recording unit
512 abnormality detecting unit
600 managing apparatus
605 management program
606 map data
650 inspection result DB
700 terminal
800 network

1. A receiving apparatus mounted on a moving body, the receiving apparatus comprising:
a receiving circuit configured to receive radio waves transmitted from a radio wave sensor attached to a structure installed on a road, and generate feature information including at least one of a reception level, an S/N ratio, and a frequency of the radio waves received;
a location detector configured to detect a location of the moving body; and
a recording processor configured to record the location of the moving body detected by the location detector in association with the feature information generated by the receiving circuit on the basis of the radio waves received at the location of the moving body.

2. The receiving apparatus according to claim 1, further comprising a memory configured to store a specific area related to detection of an object performed by the radio wave sensor,
wherein the recording processor records the location of the moving body in association with the feature information when the location of the moving body detected by the location detector is within the specific area stored in the memory.

3. The receiving apparatus according to claim 2, wherein the memory stores the specific area being a detection area where the radio wave sensor can detect an object in a state where the radio wave sensor has no abnormality related to transmission of the radio waves.

4. The receiving apparatus according to claim 2, wherein the recording processor records the location of the moving body and the feature information in association with each other at each of multiple locations within the specific area.

5. The receiving apparatus according to claim 1, further comprising an abnormality detecting processor configured to detect an abnormality in the radio wave sensor on the basis of the location and the feature information recorded by the recording processor.

6. The receiving apparatus according to claim 5, wherein the abnormality detecting processor detects the abnormality by comparing the feature information recorded by the recording processor with reference information including at least one of a proper range of reception levels, a proper range of S/N ratios, and a proper range of frequencies of the radio waves at the location of the moving body associated with the feature information.

7. The receiving apparatus according to claim 1, wherein the moving body is a vehicle.

8. The receiving apparatus according to claim 1, wherein the moving body is a flying object;
the location detector detects a location of the flying object including a height of the flying object; and
the recording processor records the location in association with the feature information generated by the receiving circuit on the basis of the radio waves received at the location.

9.-10. (canceled)

11. The receiving apparatus according to claim 3, wherein the recording processor records the location of the moving body and the feature information in association with each other at each of multiple locations within the specific area.

12. The receiving apparatus according to claim 2, further comprising an abnormality detecting processor configured to detect an abnormality in the radio wave sensor on the basis of the location and the feature information recorded by the recording processor.

13. The receiving apparatus according to claim 3, further comprising an abnormality detecting processor configured to detect an abnormality in the radio wave sensor on the basis of the location and the feature information recorded by the recording processor.

14. The receiving apparatus according to claim 4, further comprising an abnormality detecting processor configured to detect an abnormality in the radio wave sensor on the basis of the location and the feature information recorded by the recording processor.

15. The receiving apparatus according to claim 2, wherein the moving body is a vehicle.

16. The receiving apparatus according to claim 3, wherein the moving body is a vehicle.

17. The receiving apparatus according to claim 4, wherein the moving body is a vehicle.

18. The receiving apparatus according to claim 5, wherein the moving body is a vehicle.

19. The receiving apparatus according to claim 6, wherein the moving body is a vehicle.

20. The receiving apparatus according to claim 2, wherein the moving body is a flying object;
the location detector detects a location of the flying object including a height of the flying object; and
the recording processor records the location in association with the feature information generated by the receiving circuit on the basis of the radio waves received at the location.

21. An abnormality detecting system configured to detect an abnormality in a radio wave sensor attached to a structure installed on a road, comprising:
a receiving apparatus mounted on a moving body; and
a managing apparatus,
wherein the receiving apparatus includes
a receiving circuit configured to receive radio waves transmitted from the radio wave sensor and generate feature information including at least one of a reception level, an S/N ratio, and a frequency of the radio waves received,
a location detector configured to detect a location of the moving body, and
a recording processor configured to record the location of the moving body detected by the location detector in association with the feature information generated by the receiving circuit on the basis of the radio waves received at the location of the moving body; and
the managing apparatus detects the abnormality in the radio wave sensor on the basis of the location and the feature information recorded by the recording processor.

22. The abnormality detecting system according to claim 21, wherein the managing apparatus generates map information in which a result of detection of abnormality in the radio wave sensor is associated with the location of the radio wave sensor where the abnormality has been detected.
